(19) United States
(12) Patent Application Publication
(10) Pub. No.: US 2022/0319029 A1
(43) Pub. Date: Oct. 6, 2022

(54) METHOD FOR DETERMINING DEPTH FROM IMAGES AND RELATIVE SYSTEM

(71) Applicant: ALMA MATER STUDIORUM - UNIVERSITA' DI BOLOGNA, BOLOGNA (IT)

(72) Inventors: Davide PALLOTTI, BOLOGNA (IT); Matteo POGGI, BOLOGNA (IT); Fabio TOSI, BOLOGNA (IT); Stefano MATTOCCIA, BOLOGNA (IT)

(21) Appl. No.: 17/595,290

(22) PCT Filed: May 5, 2020
(86) PCT No.: PCT/IT2020/050108

§ 371 Date: Nov. 12, 2021

(30) Foreign Application Priority Data
May 17, 2019 (IT) 102019000006964

(51) Int. Cl. G06T 7/593; G06T 7/521

(52) U.S. Cl. CPC G06T 7/593; G06T 7/521; G06T 2207/20081; G06T 2207/20084; G06T 2207/10028

(57) ABSTRACT

A method for determining the depth from digital images (R, T) relating to scenes (I), comprising the following steps: A. acquiring at least one digital image (R, T) of a scene (I); B. acquiring sparse depth values (Sᵢⱼ) of said scene (I) relating to one or more of said pixels (pᵢⱼ) of said digital image (R, T); C. generating meta-data related to each pixel (pᵢⱼ) of said digital image (R, T) acquired in said step A correlated with the depth to be estimated of said image (I); D. modifying said meta-data generated in said step C, relating to each pixel (pᵢⱼ) of said digital image; and E. optimizing said meta-data modified in said step D, so as to obtain a map representative of the depth of said digital image (R, T) for determining the depth of said digital image (R, T) itself.

The present invention relates to a method for determining the depth from images and relative system.

More specifically, the invention relates to a method for determining the depth from digital images, studied and implemented in particular to increase the effectiveness of solutions according to the state of the art for determining the disparity in images, and therefore for determining the depth of the points of the scene of an image, based on automatic and non-automatic learning, using sparce information obtained externally of the process of determining the depth as a guide, by sparse meaning information with density equal to or lower than that of the images to be processed.

In the following the description will be addressed to the determination of digital stereo images, preferably acquired through a stereo system, but it is clear that the same should not be considered limited to this specific use, being it extendable to a different number of images, as it will be better clarified in the following. Among other things, it is considered that the data can be generated by any system for inferring the depth (based on the images processing, active depth sensors, Lidar or any other method capable of inferring the depth), as long as recorded with the input images according to known techniques, as better explained below.

As is well known, obtaining an estimate of dense and precise depth from digital images is essential for higher level applications, such as artificial vision, autonomous driving, 3D reconstruction, and robotics.

Depth detection in images can generally be performed using active sensors, such as LiDAR—Light Detection and Ranging or Laser Imaging Detection and Ranging, which is a known detection technique that allows determining the distance of an object or surface using a laser pulse, or standard cameras.

The first class of devices suffers some limitations, while the second one depends on the technology used to infer the depth.

For example, sensors based on structured light have a limited range and are ineffective in outdoor environments; while LiDARs, although very popular, provide only extremely sparse depth measurements and can have flaws when it comes to reflective surfaces.

Instead, passive sensors, based on standard cameras, potentially allow to obtain an estimate of dense depth in any environment and application scenario.

The estimate of depth (or even “depth”) from images can be obtained, through different approaches, starting from one or more images. The most common case or approach, but certainly not the only, is represented by the use of two horizontally aligned images.

In this configuration, called stereo, the depth can be obtained by triangulation, once that, for each point of the scene, the horizontal deviation between its coordinates in the reference image (for example, the left) and of the target (for example, the right) has been calculated. To obtain this result, it is necessary to find the correspondences between the pixels of the two images. This can be done by considering, for each pixel in the reference image, all the possible matching hypotheses, comparing it with the pixels of the target.

By processing these two images, reference and target, it is possible to reconstruct the depth of the taken scene, due to the particular geometry of the stereoscopic system, the epipolar geometry.

Thanks to it, it is possible to simplify the problem of finding correspondences between homologous points of the two images. In particular, using the standard shape of the stereo camera it is possible to simplify the search for such correspondence by bringing the problem from a two-dimensional plane to a single dimension one, since from the theory it is known that homologous pixels lie on the same scanline.

In particular, by construction, a point that in the reference image is at the coordinates of the pixel (x, y), in the target image it will be in position (x-d, y), where d indicates the deviation to be estimated, called disparity.

Therefore, having the disparity of each point, it would be ideally possible to have the exact measurement of the depth in each pixel of the image.

It is known, in fact, the relationship between the depth Z and the disparity D in the stereo case is given by the following relationship

$$Z = \frac{Baseline \cdot Focal}{D}$$

Therefore, the depth Z and the disparity D are completely interchangeable, according to the use scenario.

The task of identifying homologous pixels in the reference and target images and of calculating the respective disparity is entrusted to the stereo matching algorithms.

The general idea behind these algorithms is to compare each pixel of the reference image with those of the target image, and thus to identify the corresponding pixel, so as to triangulate its distance in the scene.

The simplest approach (and therefore not always the most used) is that of comparing the intensity of the pixels of the reference image of coordinates with the intensity of the pixels of the target image at coordinates having the same height, but moved by a quantity d, which represents the disparity sought, between 0 and D.

In particular, by defining, for simplicity and economy of calculation, a maximum range [0: D] to look for matches, scores will be calculated between each pixel in the reference image and the possible couplings or matches (x-0, y) . . . (x-D, y) in the target image.

These scores are commonly referred to as matching costs. For example, similar pixels may correspond at low costs. In particular, these can be obtained by dissimilarity functions, according to which a low cost will be assigned to similar pixels, or similarity functions, according to which high scores will correspond to similar pixels.

However, depending on the specific cost function used, similar pixels may correspond at low cost.

Furthermore, for some methods that can be used with the proposed method, the cost cannot be defined in such a simple way but, in any case, it is always possible to identify a meta-representation of these costs for any method in different processing stages.

The estimated disparity d for a pixel is determined by choosing the pixel (x-d, y) in the target that corresponds to the best matching as described above.

Usually, a stereo algorithm follows two main steps:
an initial calculation of the matching costs; and
their aggregation/optimization, the latter necessary to obtain accurate and spatially consistent results, since the initial estimate takes into account only local information and not the global context of the scene.

The first step can be summarized in the pseudo-code below, let H and W be the height and width of the images respectively

```
cost_volume:
input: image L[H][W], image R[H][W]
output: cost_volume[H][W][D]
foreach i in 0...H
  foreach j in 0...W
  for each d in 0...D
    cost_volume[i][j][d] = cost_function(L[i][j], R[i][j − d])
```

A possible cost function or cost_function can be the absolute difference between the pixel intensities (in this case a dissimilarity function)

cost_function(x,y)=abs(x−y)

therefore, the lower the difference in intensity between the pixels, the greater the probability that the two pixels of the reference image and the target image coincide or are the same.

After the optimization phase, which varies from algorithm to algorithm, disparities will be selected, for example by following the pseudocode below

select_disparity:
input: cost_volume[H][W][D]
output: disparity[H][W]
foreach i in 0...H
foreach j in 0...W
disparity[ i ][ j ] = argmin(cost_volume[ i ][ j ])

The argmin function above selects the index of the minimum value of a vector. Incidentally, similarly, in the case of similarity function, this function will be replaced by the analogous operator argmax.

In this case, for each pixel we have a cost vector D and we can select the index d of the minimum cost (i.e. maximum in the case of the argmax operator).

For example, the known algorithm SGM (Semi-Global Matching) [1] follows this structure and is known for its particular optimization procedure.

Deep learning techniques are also known (mainly based on Convolutional Neural Networks or CNN) used for the stereo technique, obtaining far better results than that obtained by traditional algorithms, such as those obtained with other algorithms such as the SGM mentioned above.

Despite the model is developed by learning from data, the two main stages of calculating the match and optimization costs described above can be found in the deep learning models, with the only difference being that they are carried out in a learned way.

In particular, the matching cost calculation step will be carried out starting from features or features extracted by learning from the images.

Given a volume of features L [H] [W] [C] and R [H] [W] [C], the matching costs or meta-features can be obtained through, for example, correlation (or concatenation in the case of deep learning algorithms) as follows

correlation:
input: L[H][W][C], R[H][W][C]
output: cost_volume[H][W][D]
foreach i in 0...H
foreach j in 0...W
foreach d in 0...D
cost_volume[i][j][d] = Σ (L[i][j] * R[i][j − d])

concatenation:
input: L[H][W][C], R[H][W][C]
output: cost_volume[H][W][D][2C]
foreach i in 0...H
foreach j in 0...W
foreach d in 0...D
cost_volume[i][j][d] = L[i][j] ## R[i][j − d]

Techniques that combine depth data obtained from images (in particular, stereo using the SGM algorithm) and from external sensors (for example, Time-Of-Flight sensors, ToF) are also known.

However, the known techniques use algorithms that calculate an optimal combination of the two, for example choosing for each pixel the most correct estimate between the two obtained through the two modes.

Recently end-to-end Convolutional Neural Networks (CNN) training algorithms are spreading in the field of stereo technique with a large amount of stereo pairs (usually synthetic) to directly infer a dense map of disparities.

However, deep stereo architectures present problems when moving the domain, for example switching from synthetic data used for initial training to real target images.

It is apparent that the methods according to the prior art are extremely expensive in computational terms, such that they cannot be easily used and applied.

Furthermore, it has been found that in unfavorable conditions due to the acquisition of the image(s) (for example poor lighting) the accuracy of the map calculated with the methods according to the technique described above is unsatisfactory.

In light of the above, it is therefore an object of the present invention to propose a method for determining the depth of images which can allow an accurate determination of the depth of the images with a modest computational cost even in low light conditions.

Another object of the invention is to propose a method for determining the depth of images that can be used with any type of algorithms, regardless of the number of images used or the type of algorithm (learning or traditional).

It is therefore object of the present invention a method for determining the depth from digital images relating to scenes, comprising the following steps: A. acquiring at least one digital image of a scene, said digital image being constituted by a matrix of pixels; B. acquiring sparse depth values of said scene relating to one or more of said pixels of said digital image; C. generating meta-data related to each pixel of said digital image acquired in said step A correlated with the depth to be estimated of said image, so as to obtain a meta-data volume, given by the set of pixels of said digital image and the value of said meta-data; D. modifying said meta-data generated in said step C, relating to each pixel of said digital image, correlated with the depth to be estimated, by means of the sparse depth values acquired in said step B, so as to make predominant, within the meta-data volume generated in said step C for each pixel of said digital image correlated with the depth to be estimated, the values associated with the sparse depth value in determining the depth of each pixel and the surrounding pixels; and E. optimizing said meta-data modified in said step D, so as to obtain a map representative of the depth of said digital image for determining the depth of said digital image itself.

Always according to the invention, said meta-data relating to each pixel of said digital image correlated with the depth to be estimated of said image may comprise matching cost function associated with each one or said pixels, relative to the possible disparity data, and said sparse depth data may be disparity values associated with some pixels of said digital image.

Still according to the invention, the matching function is a similarity may be dissimilarity function.

Advantageously according to the invention, in said modifying step D, said matching cost function, associated with each of said pixels of said digital image may be modified by means of a differentiable function as function of said disparity values associated with some pixels of said digital image.

Further according to the invention, said matching cost function may be modified so as to obtain a modified matching cost function according to this equation

$${ModifiedCostVolume}_{ijd} = 1 - {v}_{ij} + {v}_{ij} \cdot k \cdot {e}^{- \frac{{( d - {S}_{ij} )}^{2}}{2 {c}^{2}}}$$

in the case of said matching cost function is a similarity function or in case of meta-data generation by neural networks, or

$${ModifiedCostVolume}_{ijd} = 1 - {v}_{ij} + {v}_{ij} \cdot k \cdot ( 1 - {e}^{- \frac{{( d - {S}_{ij} )}^{2}}{2 {c}^{2}}} )$$

in case of said matching cost function (cost_volume_{ijd}) is a dissimilarity function, wherein: vᵢⱼ is such a function that vᵢⱼ=1 with i=1 . . . W and j=1 . . . H, d=1 . . . D for each pixel (pᵢⱼ) for which there is a measure of the disparity value (Sᵢⱼ), and vᵢⱼ=0 when there is no measurement of the disparity value (Sᵢⱼ); and k and c are configurable hyper-parameters to modify the modulation intensity.

Preferably according to the invention, said hyper-parameters k and c may respectively have a value of 10 and 0.1.

Always according to the invention, said matching cost function may be obtained by correlation.

Still according to the invention, said meta-data generating step C and/or said meta-data optimizing step E may be carried out by means of learning or deep learning based algorithms, wherein said meta-data comprise specific activations out from certain levels of the neural network, and said matching cost function may be obtained by concatenation.

Further according to the invention, said learning algorithms may be based on Convolutional Neural Networks or CNN) and said modification step may be carried out on the activations correlated with the estimation of the depth of the digital image.

Preferably according to the invention, said image acquisition step A may be carried out by means of a stereo technique, so as to detect a reference image and a target image or monocular image.

Advantageously according to the invention, said acquisition phase A may be carried out by means of at least one video camera or a camera.

Further according to the invention, said acquisition phase B is carried out by means of at least one video camera or a camera and/or at least one active LiDAR sensor, Radar or ToF.

It is further object of the present invention an images detection system comprising a main image detection unit, configured to detect at least one image of a scene, generating at least one digital image, a processing unit, operatively connected to said main image detection unit, said system being characterized in that it comprises a sparse data detection unit, adapted to acquire sparse values of said scene, operatively connected with said processing unit, and in that said processing unit is configured to execute the method for determining the depth of digital images as defined above.

Always according to the invention, said main image detection unit may comprise at least one image detection device.

Still according to the invention, said main image detection unit may comprise two image detection devices for the acquisition of stereo mode images, wherein a first image detection device detects a reference image and a second image detection device detects a target image.

Advantageously according to the invention, said at least one image detection device may comprise a video camera and/or a camera, mobile or fixed with respect to a first and a second position, and/or active sensors, such as LiDARs, Radar or Time of Flight (ToF) cameras and the like.

Further according to the invention, said sparse data detection unit may comprise a further detection device for detecting punctual data of the image or scene, related to some pixels.

Preferably according to the invention, said further detection device may be a video camera or a camera or an active sensor, such as a LiDAR, Radar or a ToF camera and the like.

Always according to the invention, said sparse data detection unit may be is arranged at and/or close and/or in the same reference system of said at least one image detection device.

It is also object of the present invention a computer program comprising instructions which, when the program is executed by a processor, cause the execution by the processor of the steps A-E of the method as defined above.

It is further object of the present invention a storage means readable by a processor comprising instructions which, when executed by a processor, cause the execution by the processor of the method steps as defined above.

The present invention will be now described, for illustrative but not limitative purposes, according to its preferred embodiments, with particular reference to the figures of the enclosed drawings, wherein:

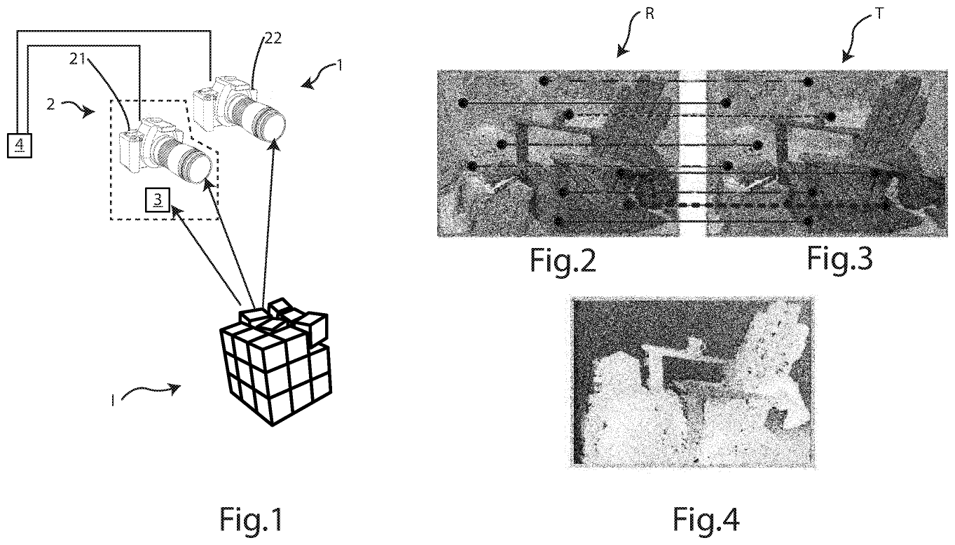

FIG. 1 shows an image detection system according to a first embodiment of the present invention in stereo configuration;

FIG. 2 shows a reference image of the detection system of FIG. 1;

FIG. 3 shows a target image of the detection system of FIG. 1, corresponding to the reference image of FIG. 2;

FIG. 4 shows a disparity map relating to the reference image of FIG. 2 and the target image of FIG. 3;

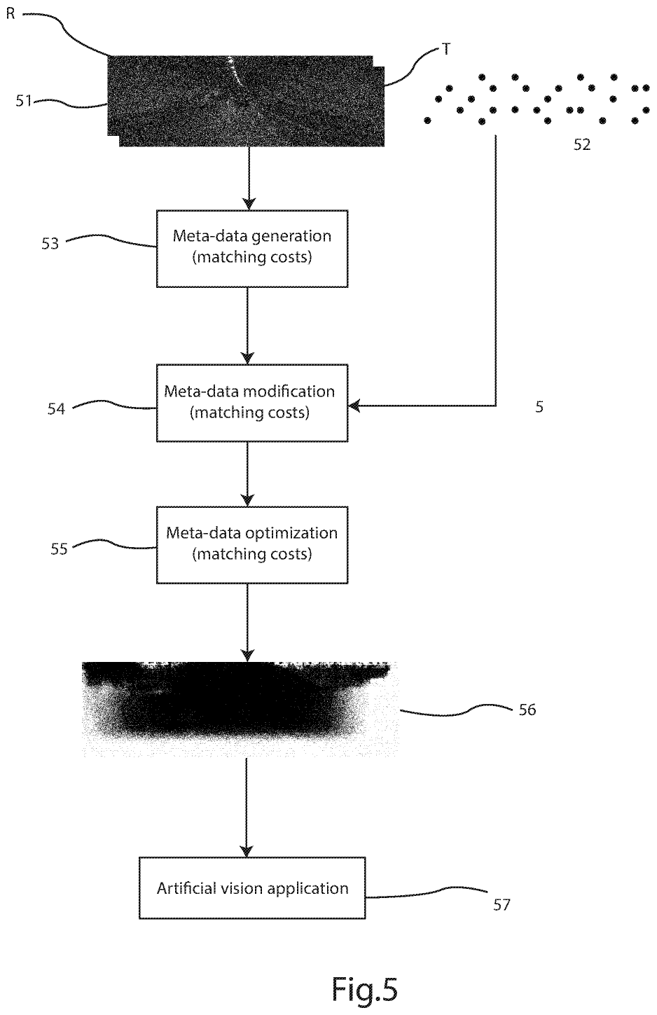

FIG. 5 shows a flowchart relating to the steps of the method for determining the depth from images according to the present invention;

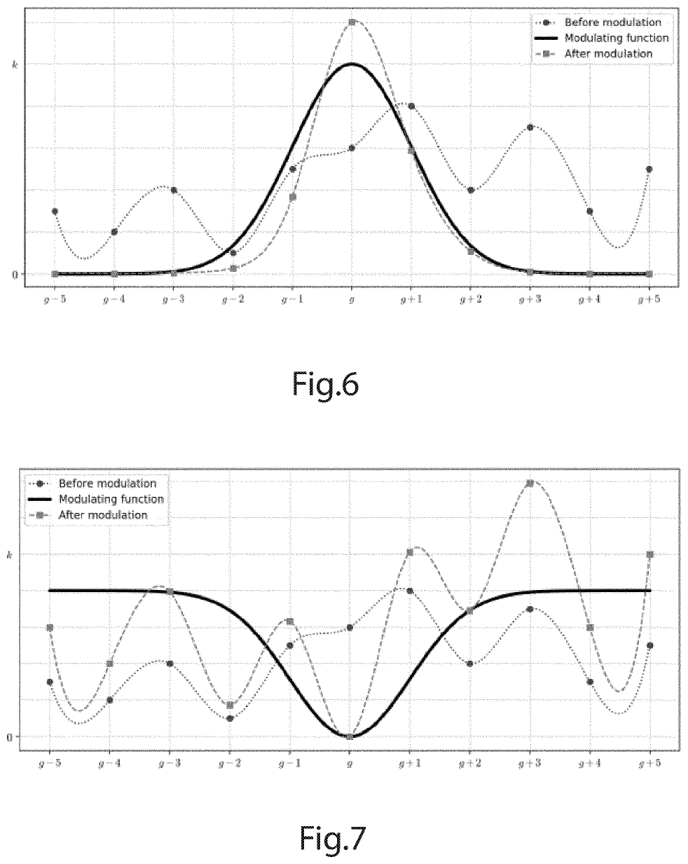

FIG. 6 shows the application of a modulation function of the method for determining the depth from images according to the present invention, in particular, in the case of amplification of the hypothesis of correct depth (as it occurs for example, but not only, in case of costs derived from similarity functions or from neural network meta-data);

FIG. 7 shows the disparity function following the application of the modulation function according to FIG. 6, in particular, in case of reduction of the hypothesis of correct depth (as it occurs in case of costs deriving from dissimilarity functions);

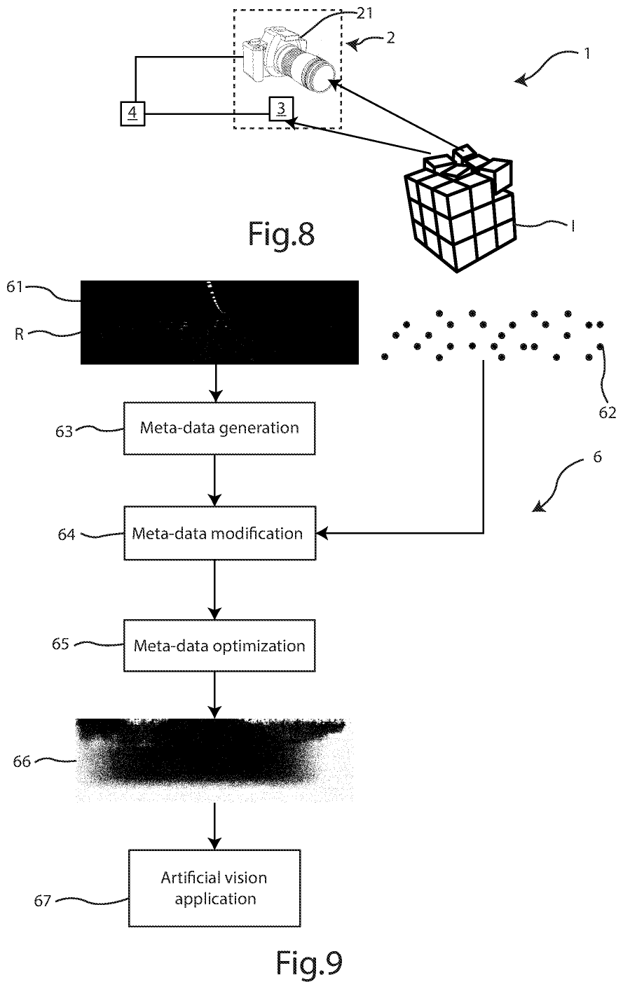

FIG. 8 shows an image detection system according to a second embodiment of the present invention, in particular in case of acquisition from a single image; and

FIG. 9 shows a flowchart relating to the steps of the method for determining the depth of images of the image detection system illustrated in FIG. 8.

In the various figures, similar parts will be indicated by the same reference numbers.

The proposed method allows the use of sparse data, better defined below, but extremely accurate, obtained by any method, such as a sensor or an algorithm, to guide an algorithm for estimating depth (or even “depth”) from single or multiple images.

Essentially, the method involves modifying the intermediate meta-data, namely the matching costs, processed by the algorithm.

These meta-data and the information they encode vary between the different algorithms and the different methodologies for estimating depth or depth (for example, from a single image or from stereo images or other methods that use multiple images).

In particular, it is necessary to identify which meta-data are closely correlated with the depth to be estimated.

The values of these meta-data are thus modified according to the depth actually measured by the external sensor/method when this measurement is available.

In the following, to better explain the operation of the method of determining the depth from images according to the present invention, reference will be made, as a first embodiment, to a detection of stereo images.

In particular, referring to FIG. 1, an image detection system is observed generically indicated by the numerical reference 1, comprising a main image detection unit 2, a sparse data detection unit 3 and a processing unit 4, functionally connected to said main image detection unit 2, and to said sparse data detection unit 3.

Said main image detection unit 2 in turn comprises two image detection devices 21 and 22, which can be a video camera or a camera, movable with respect to a first and a second position, or two detection devices 21 and 22 arranged in two different and fixed positions.

The two detection devices 21 and 22 each detect their own image (reference and target respectively) of the object or scene to be detected I. Of course, it is possible providing for the use of a plurality of detection devices, and not just two.

In particular, said main image detection unit 2 performs a detection of the scene I by means of the stereo technique, such that the image of FIG. 2 is detected by the detection device 21, while the image of FIG. 3 is detected by the detection device 22.

In the following, the image of FIG. 2, as said, acquired by the detection device 21, will be considered the reference image R, while that of FIG. 3, as mentioned, the one acquired by the detection device 22, will be considering the target image T.

The sparse data detection unit 3 comprises a further image detection device, which can be an additional camera or a camera or, also in this case, an active sensor, such as for example a LiDAR or a ToF camera.

Said sparse data detection unit 3 is arranged in correspondence, and physically in proximity, i.e., on the same reference system, of the detection device 21, which acquires said reference image. In other words, the sparse data are recorded and mapped on the same pixels as the acquired reference images.

Said sparse data detection unit 3 detects punctual data of the image or scene I, in fact relating to some pixels only of the reference image R, which are, however, very precise. In particular, reference is made to a subset of pixels less than or equal to that of the image or scene, although, from a theoretical point of view, they could potentially also be all. Obviously, with current sensors this does not seem possible.

The use of said sparse data detected by said sparse data detection unit 3 will be better clarified below.

The data acquired by said main image detection unit 2 and by said sparse data detection unit 3 are acquired by said processing unit 4, capable of accurately determining the depth of the reference image R acquired by the detection device 21 by means of the method for determining the depth of the images shown in FIG. 5, according to the present invention and better explained below.

Once the depth of a scene or an image I has been precisely determined, the same can be used, as mentioned, for various complex artificial vision use purposes, such as, for example, autonomous driving of vehicles and the like.

In order to determine the depth of the image shown in FIG. 2 of the reference R, it is necessary to determine (or estimate) for each pixel of the same, the relative disparity with respect to the target image T.

As anticipated, this can be done by means of various algorithms known in the prior art, which provide for the calculation of the matching costs of each pixel i, j (in the following the indices i and j will be used respectively to indicate the pixel of the i-th column and of the row j-th of an image and can vary respectively from 1 to W and from 1 to H, being W the nominal width of the image and H the height) of the reference image R, obtaining for each pixel i, j of said reference image R a so-called matching or association cost function, followed by an optimization step.

In this way, the selection of the disparities dᵢⱼ referred to each pixel pᵢⱼ of said reference image R is obtained.

Normally, the algorithms for determining the disparities dᵢⱼ of each pixel pᵢⱼ of said reference image R all substantially provide the aforementioned steps for calculating the matching and optimization costs.

As anticipated above, the matching costs are also commonly referred to as meta-data.

In the technique, different systems for determining and calculating meta-data can be used and detected. The method for determining the depth from images according to the present invention can be applied equally with other algorithms for determining and calculating the metadata.

Referring now to FIG. 5, as mentioned, schematically observes the flowchart of the method for determining the depth from images according to the present invention, generally indicated with the numerical reference 5, wherein 51 indicates the image acquisition step, which in the case at issue provides for the detection by stereo technique and, therefore, the detection of a reference image R and a target image T.

In the step indicated with the numerical reference 52, sparse and precise data are acquired through the sparce data detection unit.

Subsequently, the generation of the meta-data is carried out in step 53, which, as mentioned, can be obtained with an algorithm according to the prior art or by means of a learning-based algorithm.

More specifically, in the case of stereo detection, the meta-data compatible with the previous definition are, as mentioned, the costs of matching the pixels of the two images, i.e., the reference image R and the target image T.

Each matching cost identifies a possible disparity dᵢⱼ (and therefore, a possible depth of the image) to be estimated for each pixel pᵢⱼ of the image. It is therefore possible, having at the input a measure of depth for a given pixel pᵢⱼ, to convert it into disparity dᵢⱼ and to modify the costs of this pixel pᵢⱼ, so as to make this hypothesis of disparity preferred over the others.

As anticipated, traditional stereo algorithms process and collect in a three-dimensional “cost volume” the relationship between the potentially corresponding pixels between the two images (as said reference and target) in a stereo pair. For example, in the method of determining the match costs briefly described above, of the local type, the disparity is sought on the epipolar line for a number D of pixels, the cost volume would be equal to W×H×D.

The idea at the basis of the present invention consists in acting appropriately on this representation, the meta-data, favoring those disparities suggested by sparse, although precise data.

In more detail, by way of example, in the method according to the present invention, a solution consists in modulating the cost function obtained from all the costs associated to the pixels pᵢⱼ of an image by multiplying by a differentiable function, such as, for example, but not necessarily or limitedly, a Gaussian, of the measured depth, so as to minimize the cost corresponding to this value and to increase the remaining ones.

In this case, given a matrix of sparse measures indicated with S[i][j] or Sᵢⱼ with i=1 . . . W and j=1 . . . H, obtained in step 52, a mask is constructed v[i][j] (or vᵢⱼ) such that v[i][j]=1 (i.e. vᵢⱼ=1), with i=1 . . . W ej=1 . . . H, for each pixel pᵢⱼ, for which there is a valid measurement, and v[i][j]=0 (i.e. vᵢⱼ=0) when a measurement is not available.

The modulation in the above terms can be applied for example by following the pseudo-code shown below, where k and c are hyper-parameters that can be configured to change the intensity of the modulation (possible values attributable to these parameters, for exemplary purposes, could be for example k=10 and c=0.1).

```
modulation_stereo_algorithm:
input: cost_volume[H][W][D], S[H][W]
output: modified_cost_volume[H][W][D]
foreach i in 0...H
  foreach j in 0...W
  foreach d in 0...D
    modified_cost_volume[i][j][d] = 1 − v[i][j] + v[i][j] * k * (1 −
  e^{-(d - S[i][j])/2c}^{²})
```

In more synthetic and mathematical terms, the modification factor of the matching cost function of each pixel pᵢⱼ is given, in the case of Gaussian modulation, by the expression:

$${ModifiedCostVolume}_{ijd} = 1 - {v}_{ij} + {v}_{ij} \cdot k \cdot ( 1 - {e}^{- \frac{{( d - {S}_{ij} )}^{2}}{2 {c}^{2}}} )$$

in case the cost matching function (cost_volume_{ijd}) is a dissimilarity function.

Instead, if the cost matching function (cost_volume_{ijd}) is a similarity function or in the case of the generation of metadata through neural networks, the following function applies:

$${ModifiedCostVolume}_{ijd} = 1 - {v}_{ij} + {v}_{ij} \cdot k \cdot {e}^{- \frac{{( d - {S}_{ij} )}^{2}}{2 {c}^{2}}}$$

Returning to the previous case (cost matching function (cost_volume_{ijd}) as similarity function), this step of the method for determining the depth of images according to the present invention is exemplified in the flowchart with step 54, in which the meta-data are modified or modulated.

As can be seen, the formula that modifies the match costs for the pixel pᵢⱼ operates in such a way that in case of there is no precise data for the specific pixel pᵢⱼ, since the value of the mask vᵢⱼ=0, then there is no change in the matching cost for the pixel pᵢⱼ, while, if there is a precise value of the specific pixel pᵢⱼ, then, since the value of the mask vᵢⱼ=1, the matching cost of this pixel is modified, or amplified (and similarity functions are used—see FIG. 6) o attenuated (if dissimilarity functions are used—see FIG. 7) for a factor K (which, in the case at issue has been set equal to 10) and for a Gaussian function, which maximizes in case of the disparity is set equal to the effective disparity value Sᵢⱼ. In this way, the matching costs are modified by enhancing the precise disparity values with the available sparse data Sᵢⱼ.

Then, the step 55 of meta data optimization follows, which can be carried out according to any optimization scheme according to the prior art (see for example the references [1] and [2]) thus obtaining, finally, the disparity map desired as indicated in step 56, usable for any artificial vision purpose 57, such as driving a vehicle and the like.

In this way, the cost corresponding to the obtained measure will be made lower, while the others will be increased, as shown in FIG. 6, favoring the choice of the first.

In case of learning algorithms or based on deep learning, the modified meta-data correspond to specific activations, as outputs from certain levels of the neural network.

The obtained meta-data map can be used to accurately determine the depth of the image or scene taken.

It is therefore necessary to identify which activations are strictly correlated with the estimation of the image depth: in the case of stereo networks, some activations encode information similar to the matching costs of traditional algorithms, usually using correlation operators (scalar product; see also the reference [3]) or concatenation (see also the reference [4]) between the activations of the pixels in the reference R and target T images, similarly to how the matching cost is obtained based on functions, for example, the intensity of the pixels in the two images.

Such meta-data can be, for example, modulated in a similar way, as reported in the pseudo code below.

```
modulation_stereo_network:
input: cost_volume[H][W][D], S[H][W]
output: modified_cost_volume[H][W][D]
foreach i in 0...H
foreach j in 0...W
foreach d in 0...D
    modified_cost_volume[i][j][d] = 1 − v[i][j] + v[i][j] * k *
  e^{-(d - S[i][j])/2c}^{²})
```

In this way, the activations linked to the obtained measure will be increased while the remaining ones will be damped as shown in FIG. 6, favoring the choice of the former.

As said, the stereo case represents a specific use scenario, but not the only one, in which the method for determining the depth of images according to the present invention can be applied.

The sparse data will be used to modify (or even to modulate) the matching costs, providing a better representation of the same at the next optimization step.

In particular, as mentioned above, the proposed determination method can be used with any method for the generation of depth data, also based on learning (i.e., machine or deep-learning).

In a further embodiment of the present invention, the method for determining the depth of images can be applied to monocular systems.

In particular, referring to FIGS. 8 and 9, the detection system for the monocular case is observed, which provides for the use of a single detection device 21, namely, a single camera.

The monocular case therefore represents an alternative use scenario, in which the depth map is obtained by processing a single image. Typically, but not necessarily, monocular methods are based on machine/deep-learning.

The scattered data will be used to modify (or modulate) the meta-data used by the monocular method to generate the depth map.

By the determination method according to the present invention, also in case of monocular images processing, an intermediate step is performed between the generation of the meta-data and their optimization (see for example the reference [5], which shows how a monocular system can emulate meta data similar to the stereo case, therefore suitable for modulation), therefore the flowchart shown in FIG. 5 described above is valid in general terms also in case of image acquisition by means of a detection unit 2 based on a single detection device 21.

Through sparse, but accurate measurements obtained from any external method/sensor (Lidar, radar, Time-of-flight or of any nature but also based on the same images) modifying the previously extracted meta-data is possible, in order to allow a better optimization and therefore obtaining more accurate final maps.

In the case of FIG. 8, the external sensor allows to recover the 3D structure which, for example due to poor lighting conditions, is inaccurate if calculated with methods according to the prior art.

In the above illustrative description of the method for determining the depth of images, other techniques known in the literature for obtaining depth maps from images can be considered.

In fact, in addition to the monocular and stereo case, it is possible to infer the depth of the images from more than two images acquired from different points of view (bottom left) or from a single moving camera (bottom right). In these cases, the sparse data can be used both in the form of a depth measure and in its disparity equivalent form.

In both cases, the proposed method can be profitably applied to the generated meta-data.

In particular, with reference to FIG. 8, an image detection system 1 according to the present invention is observed, which, unlike that illustrated in FIG. 1, comprises the main image detection unit 2 having a single detection device of images 21, which also in this case can be a video camera or a camera or an active sensor.

In this case, of course, the image detection system 1 will use a monocular system for the acquisition of the images of scene I. Instead, as in the previous embodiment, the sparse data detection unit 3, will acquire precise scattered data of the scene I to transmit them to the processing unit 4, in which a computer program is installed which is executed so as to carry out the method as illustrated in FIG. 9.

In particular, as it can be seen the flowchart illustrates the step 61 for acquiring monocular images, the step 62 for acquiring sparse data from scene I, 63 for generating meta-data, the step for modifying the meta-data 64, completely analogous to the step 54 shown and described in relation to FIG. 5, the step of optimizing the meta-data 65, obtaining the disparity map 66, and the application of the acquired estimate of the disparity for artificial vision 67.

An advantage of the present invention is that of allowing an improvement of the functions, which encode the correspondence relationships between the pixels between the reference images and the target image, so as to improve the accuracy of the detection of the depth from images.

In fact, the method according to the invention also improves the functionality of the currently known methods and can be used seamlessly with pre-formed models, obtaining significant precision improvements.

A further advantage of the invention is also that of being used to train neural networks, such as in particular Convolutional Neural Networks or CNN from scratch, in order to take full advantage of the input guide and therefore to significantly improve the accuracy and the overall robustness of the detections.

It is also an advantage of the present invention that of being implementable also with conventional stereo matching algorithms such as SGM (Semi-Global Matching) or any traditional algorithm, which exhibits a compatible representation of meta-data, making significant improvements.

The present invention has been described for illustrative but not limitative purposes, according to its preferred embodiments, but it is to be understood that modifications and/or changes can be introduced by those skilled in the art without departing from the relevant scope as defined in the enclosed claims.

### REFERENCES

[1] Hirschmuller H., Stereo Processing by Semi-Global Matching and Mutual Information, TPAMI 2007.
[2] De-Maeztu L., Mattoccia S., Villanueva A., Cabeza R., “Linear stereo matching”, ICCV 2011.
[3] Mayer, N., IIg, E., Häusser, P., Fischer, P., Cremers, D., Dosovitskiy, A. and Brox, T., “A Large Dataset to Train Convolutional Networks for Disparity, Optical Flow, and Scene Flow Estimation”, CVPR 2016.
[4] Kendall, A., Martirosyan, H., Dasgupta, S., Henry, P., Kennedy, R., Bachrach, A. and Bry, A., 2017. “End-to-end learning of geometry and context for deep stereo regression”, ICCV 2017.
[5] Tosi, F., Aleotti, F., Poggi, M. and Mattoccia, S., 2019. “Learning monocular depth estimation infusing traditional stereo knowledge”, CVPR 2019.

1. A method for determining the depth from digital images (R, T) relating to scenes (I), comprising the following steps:
A. acquiring (51, 61) at least one digital image (R, T) of a scene (I), said digital image (51, 61) being constituted by a matrix of pixels (pᵢⱼ with i=1 . . . W, j=1 . . . H);
B. acquiring (52, 62) sparse depth values (Sᵢⱼ) of said scene (I) relating to one or more of said pixels (pᵢⱼ) of said digital image (R, T);
C. generating (53, 63) meta-data related to each pixel (pᵢⱼ) of said digital image (R, T) acquired in said step A correlated with the depth to be estimated of said image (I), so as to obtain a meta-data volume, given by the set of pixels (pᵢⱼ) of said digital image (R, T) and the value of said meta-data;
D. modifying (54, 64) said meta-data generated in said step C, relating to each pixel (pᵢⱼ) of said digital image (R, T), correlated with the depth to be estimated, by means of the sparse depth values (Sᵢⱼ) acquired in said step B, so as to make predominant, within the meta-data volume (53, 63) generated in said step C for each pixel (pᵢⱼ) of said digital image (R, T) correlated with the depth to be estimated, the values associated with the sparse depth value (Sᵢⱼ) in determining the depth of each pixel (pᵢⱼ) and the surrounding pixels; and
E. optimizing said meta-data (55,65) modified in said step D, so as to obtain a map (56, 66) representative of the depth of said digital image (R, T) for determining the depth of said digital image (R, T) itself.

2. The method according to claim 1, characterized in that said meta-data relating to each pixel (pᵢⱼ) of said digital image (I) correlated with the depth to be estimated of said image (I) comprise matching cost function (cost_volume_{ijd}) associated with each one or said pixels (pᵢⱼ), relative to the possible disparity data (dᵢⱼ with i=1 . . . W, j=1 . . . H, d=0 . . . ), and
in that said sparse depth data are disparity values (Sᵢⱼ) associated with some pixels (pᵢⱼ) of said digital image (R, T).

3. The method according to claim 2, characterized in that the matching function (cost_volume_{ijd}) is a similarity or dissimilarity function.

4. The method according to claim 1, characterized in that in said modifying step D (54, 64), said matching cost function (cost_volume_{ijd}), associated with each of said pixels (pᵢⱼ) of said digital image (R, T) is modified by means of a differentiable function as function of said disparity values (Sᵢⱼ) associated with some pixels (pᵢⱼ) of said digital image (R, T).

5. The method according to claim 4, characterized in that said matching cost function (cost_volume_{ijd}) is modified so as to obtain a modified matching cost function (ModifiedCostVolume_{ijd}) according to this equation
$${ModifiedCostVolume}_{ijd} = 1 - {v}_{ij} + {v}_{ij} \cdot k \cdot {e}^{- \frac{{( d - {S}_{ij} )}^{2}}{2 {c}^{2}}}$$
in the case of said matching cost function (cost_volume_{ijd}) is a similarity function or in case of meta-data generation by neural networks, or
$${ModifiedCostVolume}_{ijd} = 1 - {v}_{ij} + {v}_{ij} \cdot k \cdot ( 1 - {e}^{- \frac{{( d - {S}_{ij} )}^{2}}{2 {c}^{2}}} )$$
in case of said matching cost function (cost_volume_{ijd}) is a dissimilarity function, wherein:
vᵢⱼ is such a function that vᵢⱼ=1 with i=1 . . . W and j=1 . . . H, d=1 . . . D for each pixel (pᵢⱼ) for which there is a measure of the disparity value (Sᵢⱼ), and vᵢⱼ=0 when there is no measurement of the disparity value (Sᵢⱼ); and
k and c are configurable hyper-parameters to modify the modulation intensity.

6. The method according to claim 5, characterized in that said hyper-parameters k and c respectively have a value of 10 and 0.1.

7. The method according to claim 2, characterized in that said matching cost function (cost_volume_{ijd}) is obtained by correlation.

8. The method according to claim 1, characterized in that said meta-data (53, 63) generating step C and/or said meta-data (55, 65) optimizing step E are carried out by means of learning or deep learning based algorithms,
wherein said meta-data comprise specific activations out from certain levels of the neural network, and
in that said matching cost function (cost_volume_{ijd}) is obtained by concatenation.

9. The method according to claim 8, characterized
in that said learning algorithms are based on Convolutional Neural Networks or CNN) and
in that said modification step (54, 64) is carried out on the activations correlated with the estimation of the depth of the digital image (R, T).

10. The method according to claim 1 characterized in that said image acquisition step A (51, 61) is carried out by means of a stereo technique, so as to detect a reference image (R) and a target image (T) or monocular image.

11. The method according to claim 1 characterized in that said acquisition phase A (51, 61) is carried out by means of at least one video camera or a camera.

12. The method according to claim 1 characterized in that said acquisition phase B (52, 62) is carried out by means of at least one video camera or a camera and/or at least one active LiDAR sensor, Radar or ToF.

13. An images detection system (1) comprising:
a main image detection unit (2), configured to detect at least one image of a scene (I), generating at least one digital image,
a processing unit (4), operatively connected to said main image detection unit (2),
said system (1) being characterized
in that it comprises a sparse data detection unit (3), adapted to acquire (52, 62) sparse values (Sᵢⱼ) of said scene (I), operatively connected with said processing unit (4), and
in that said processing unit (4) is configured to execute the method for determining the depth of digital images according to claim 1.

14. The system (1) according to claim 13, characterized in that said main image detection unit (2) comprises at least one image detection device (21, 22).

15. The system (1) according to claim 14, characterized in that said main image detection unit (2) comprises two image detection devices (21, 22) for the acquisition of stereo mode images, wherein a first image detection device (21) detects a reference image (R) and a second image detection device (22) detects a target image (T).

16. The system (1) according to claim 14, characterized in that said at least one image detection device (21, 22) comprises a video camera and/or a camera, mobile or fixed with respect to a first and a second position, and/or active sensors, such as LiDARs, Radar or Time of Flight (ToF) cameras and the like.

17. The system (1) according to claim 13, characterized in that said sparse data detection unit (3) comprises a further detection device for detecting punctual data of the image or scene (I), related to some pixels (pᵢⱼ).

18. The system (1) according to claim 17, characterized in that said further detection device is a video camera or a camera or an active sensor, such as a LiDAR, Radar or a ToF camera and the like.

19. The system (1) according to claim 1, characterized in that said sparse data detection unit (3) is arranged at and/or close and/or in the same reference system of said at least one image detection device (21).

20. Computer program comprising instructions which, when the program is executed by a processor, cause the execution by the processor of the steps A-E of the method according to claim 1.

21. Storage means readable by a processor comprising instructions which, when executed by a processor, cause the execution by the processor of the method steps according to claim 1.
